(19) United States
(12) Patent Application Publication
(10) Pub. No.: US 2018/0276236 A1
(43) Pub. Date: Sep. 27, 2018

(54) STORAGE SYSTEM

(71) Applicant: NEC Corporation, Tokyo (JP)

(72) Inventor: James Shunsuke Reynolds, Tokyo (JP)

(73) Assignee: NEC Corporation, Tokyo (JP)

(21) Appl. No.: 15/912,908

(22) Filed: Mar. 6, 2018

(30) Foreign Application Priority Data
Mar. 22, 2017 (JP) 2017-055640

(51) Int. Cl. G06F 17/30; G06F 11/14

(52) U.S. Cl. CPC G06F 17/30156; G06F 17/30091; G06F 2201/84; G06F 11/1464; G06F 11/1453

(57) ABSTRACT

A storage system includes a deduplication storage device, a plurality of readout devices each configured to read out a file based on a file table showing a storing state of the file, a file table acquisition unit configured to acquire the file table in which file specifying information that specifies the file and divided data specifying information that specifies the divided data unit constituting the file are associated with each other, and a file table change unit configured to change the file table such that a plurality of the files constitute a group, based on the file table.

### INCORPORATION BY REFERENCE

The present invention is based upon and claims the benefit of priority from Japanese patent application No. 2017-055640, filed on Mar. 22, 2017, the disclosure of which is incorporated herein in its entirety by reference.

### TECHNICAL FIELD

The present invention relates to a storage system, and in particular, to a storage system that controls data storage on a storage device having a duplicate storage elimination function.

### BACKGROUND ART

Recently, along with development and spread of computers, various types of information are digitized. As devices for storing such digitized data, storage devices such as a magnetic tape and a magnetic disk have been known. Data to be stored is increased day by day and the amount becomes enormous, which requires a large capacity storage system. Further, reliability is also required, while the cost spent for the storage device should be reduced. In addition, it is also required that data can be easily taken out later. As a result, there is a demand for a storage system capable of automatically enhancing the storage capacity and performance, reducing the storage cost by eliminating duplicate storage, and having high redundancy.

In consideration of such a circumstance, a content address storage system has been developed recently, as disclosed in JP 2005-235171 A (Patent Literature 1). The content address storage system distributively store the data in a plurality of storage devices, and according to a unique content address specified according to the content of the data, the storage location where the data is stored is identified. Further, there is also a content address storage system in which data is divided into a plurality of fragments, and with additional fragments serving as redundant data, the fragments are stored in a plurality of storage devices respectively.

In the content address storage systems described above, by designating a content address, it is possible to read out the data, that is, fragments, stored in the storage location identified by the content address, and restore the given data before division from the fragments.

The content address is generated based on a value uniquely generated according to the content of the data, that is, a hash value of the data, for example. As such, in the case of duplicate data, it is possible to acquire the data of the same content by referring to the data of the same storage location. Accordingly, there is no need to store duplicate data separately, whereby it is possible to eliminate duplicate record to thereby reduce the data capacity.

In particular, in the deduplication storage system as described above, data to be written, such as a file, is divided into a plurality of block data units having a predetermined capacity and compressed, and written in the storage device. In this way, by eliminating duplicate storage in block data units that are formed by dividing a file, the duplicate rate is increased, whereby the data capacity is reduced.

In many organizations, a dedicated backup system for backing up business data is prepared so as to be able to continue business even if data loss occurs due to a device failure, erroneous operation, disaster, or the like. In general, as backup data has a high duplicate rate, a deduplication storage device as described above is used for a backup system.

Under such a circumstance, in an organization having a complicated information technology (IT) system, it is required to integrally manage a large number of backup servers to back up a large number of business servers. Meanwhile, in order to continue business without any interruption even at the time of data loss, it is required to restore backup data at high speed in a short period. Here, an exemplary configuration of a storage system using a deduplication storage device for backup will be described with reference to FIGS. 1 and 2.

A storage system illustrated in FIG. 1 includes one or more business servers 10 having backup target data, one or more backup servers 20 that execute a backup process, a backup management server 30 that manages backup, and a deduplication storage device 40 in which backup data is to be stored. Here, all of the business servers 10 are connected with all of the backup servers 20 over networks, and all of the backup servers 20 are connected with the deduplication storage device 40 over networks. Further, the backup management server 30 is connected with the business servers 10, the backup servers 20, and the deduplication storage device 40.

FIG. 2 illustrates constituent elements provided to the respective devices. The business server 10 includes one ore more backup target files 11.

The backup server 20 includes a file read/write unit 22 for reading out a file from and writing a file to the business server 10 (or deduplication storage device 40). The backup server 20 also includes a backup job 21 that defines which file in the business server 10 should be backed up or restored, and realizes backup of a file in the deduplication storage device 40 or restoration of a file in the business server 10 with use of the file read/write unit 22.

The backup server 20 also includes a client side deduplication module 23 having a chunk dividing/combining unit 24, a storage cooperated deduplication unit 25, and a chunk holding region 26. The chunk dividing/combining unit 24 divides a readout backup target file into chunks (data unit of deduplication), and determines chunks not having been stored in the deduplication storage device 40 with use of the storage cooperated deduplication unit 25. Then, the storage cooperated deduplication unit 25 writes only new chunks in the deduplication storage device 40. As for the chunks having been stored, the chunks stored in the deduplication storage device 40 are allowed to be referred to. The chunk holding region 26 holds part of the divided chunks like a cache in order to speed up restoration.

The backup management server 30 includes a backup job setting unit 31, and sets a backup job 21 of each backup server 20. The backup management server 30 includes a backup/restoration execution unit 32, and controls execution of the backup job 21 of each backup server 20.

The deduplication storage device 40 includes a storage region 42 in which data of the backup target file 11 of the business server 10 is finally stored. The deduplication storage device 40 also includes a deduplication unit 41 having a function of deduplicating written data (dividing data into chunks, managing a correspondence relationship between a chunk and a file, and the like).

In the storage system configured as describe above, in the case of backing up the business system environment, that is, backing up all of the backup management servers 10, a backup target file of each business server 10 is read by each backup server 20 according to each backup job set in advance, under control of the backup management server 30. In general, a backup job is set based on the circumstance at the time of backup such as backup rapidity.

In the backup server 20, the chunk dividing/combining unit 24 divides a backup target file into chunks, and the storage cooperated deduplication unit 25 checks whether or not each chunk exists in the deduplication storage device 40. Then, the storage cooperated deduplication unit 25 writes, in the storage device 40, data of a chunk not existing in the deduplication storage device 40. Meanwhile, when the chunk exists, a hash value of the chunk is transmitted instead of the data, and the existing data is referred to in the deduplication storage device 40. Thereby, it is deemed that the data of the chunk is written. At the time of backup, the backup server 30 stores part of the chunks, constituting the readout backup target file, in the chunk holding region 26 of itself.

On the other hand, when there is a failure in the business server 10, restoration from a backup storage is required. At that time, restoration is performed in such a manner that a file of the business server 10 to be restored is read from the deduplication storage device 40 and is written to the business server 10, by the backup server 20 that backed up the file of the business server 10 to be restored, under control of the backup management server 30.

In the restoration process, when the backup server 20 reads out data from the deduplication storage device 40, data is read in chunk units, and a file is created by the chunk dividing/combining unit 24 and restored in the business server 10. It should be noted that a restoration target file of a business server 10 is the same as a backup target file set in the backup job, and the same backup server 20 is in charge of backup and restoration of the same file.

Further, when a chunk is read from the deduplication storage device 40, the chunk holding region 26 is checked, and when the chunk has been stored in the chunk holding region 26, the chunk is not read from the deduplication storage device 40 but is directly read by using the data in the chunk holding region 26. By reading out the chunk not from the deduplication storage device 40 but from the chunk holding region 26, it is possible to reduce the amount of data read from the deduplication storage device 40 and to reduce the restoration time.

[Patent Literature 1] JP 2005-235171 A

[Patent Literature 2] JP 2011-198321 A

However, the capacity of the chunk holding regions 26 of the entire backup servers 20 is very small, relative to the total amount of data of the backup target files included in the entire business servers 10, in general. Accordingly, in the restoration method described above, effects in reduction of the data transfer amount and reduction of the restoration time are lowered, which cannot realize further speed-up of restoration.

Further, at the time of backup, a backup job may be set based on the rapidity/easiness of a backup process. Due to such a backup job, there is a case where the setting is not optimum for restoration. For example, in JP 2011-198321 A (Patent Literature 2), there is a case where a backup condition record is stored, and restoration is performed based on such a record. In this way, when using the backup setting for restoration as it is, data of a plurality of business servers may be backed up and restored by one backup server 20, or one file may be restored from a plurality of backup servers 20. In that case, there is a problem that the backup servers 20 cannot be used efficiently, whereby restoration cannot be performed faster.

### SUMMARY

In view of the above, an exemplary object of the present invention is to solve the aforementioned problem, that is, a problem that it is impossible to speed up data readout and restoration in a storage system in which data is stored in a deduplicated manner.

A storage system, according to an exemplary aspect of the present invention, includes

a deduplication storage device configured to store divided data units obtained by dividing a file into a plurality of data units, and eliminate duplicate storage by referring to the divided data unit of a same content that is already stored,

a plurality of readout devices each configured to read out the file from the deduplication storage device, based on a file table showing a storing state of the file in the deduplication storage device,

a file table acquisition unit configured to acquire the file table in which file specifying information that specifies the file and divided data specifying information that specifies the divided data unit constituting the file are associated with each other, and

a file table change unit configured to change the file table such that a plurality of the files constitute a group, based on the file table.

An information processing apparatus, according to an exemplary aspect of the present invention, includes

a file table acquisition unit configured to acquire a file table, and

a file table change unit.

The file table shows a storing state of a file in a deduplication storage device configured to store divided data units obtained by dividing the file into a plurality of data units, and eliminate duplicate storage by referring to the divided data unit of the same content that is already stored, and the file table is configured such that file specifying information that specifies the file and divided data specifying information that specifies the divided data unit constituting the file are associated with each other.

The file table change unit is configured to change the file table such that a plurality of the files constitute a group, based on the file table.

A program, according to an exemplary aspect of the present invention, causes an information processing apparatus to realize

a file table acquisition unit configured to acquire a file table, and

a file table change unit.

The file table shows a storing state of a file in a deduplication storage device configured to store divided data units obtained by dividing the file into a plurality of data units and eliminate duplicate storage by referring to the divided data unit of a same content that is already stored, and the file table is configured such that file specifying information that specifies the file and divided data specifying information that specifies the divided data unit constituting the file are associated with each other.

The file table change unit is configured to change the file table such that a plurality of the files constitute a group, based on the file table.

An information processing method, according to an exemplary aspect of the present invention, is an information processing method performed by a storage system including a deduplication storage device and a plurality of readout devices. The deduplication storage device is configured to store divided data units obtained by dividing a file into a plurality of data units and eliminate duplicate storage by referring to the divided data unit of the same content that is already stored. Each of the readout devices is configured to read out the file from the deduplication storage device based on a file table showing a storing state of the file in the deduplication storage device. The method includes

acquiring a file table in which file specifying information that specifies the file and divided data specifying information that specifies the divided data unit constituting the file are associated with each other, and

changing the file table such that a plurality of the files constitute a group, based on the file table.

As the present invention is configured as described above, it is possible to speed up data readout and restoration in a storage system in which data is stored in a deduplicated manner.

### BRIEF DESCRIPTION OF THE DRAWINGS

FIG. 1 is a block diagram illustrating an overall configuration of a storage system according to a first exemplary embodiment of the present invention;

FIG. 2 is a block diagram illustrating a configuration of a storage system related to the present invention;

FIG. 3 is a block diagram illustrating a configuration of a storage system according to a first exemplary embodiment of the present invention;

FIG. 4 illustrates exemplary data stored in the restoration target file table disclosed in FIG. 3;

FIG. 5 illustrates exemplary data stored in the chunk table disclosed in FIG. 3;

FIG. 6 illustrates a state of processing performed by the backup management server disclosed in FIG. 3;

FIG. 7 is a flowchart illustrating an operation of the storage system disclosed in FIG. 3;

FIG. 8 is a flowchart illustrating an operation of the storage system disclosed in FIG. 3;

FIG. 9 is a flowchart illustrating an operation of the storage system disclosed in FIG. 3; and

FIG. 10 is a block diagram illustrating a configuration of a storage system according to a second exemplary embodiment of the present invention.

### EXEMPLARY EMBODIMENTS

### First Exemplary Embodiment

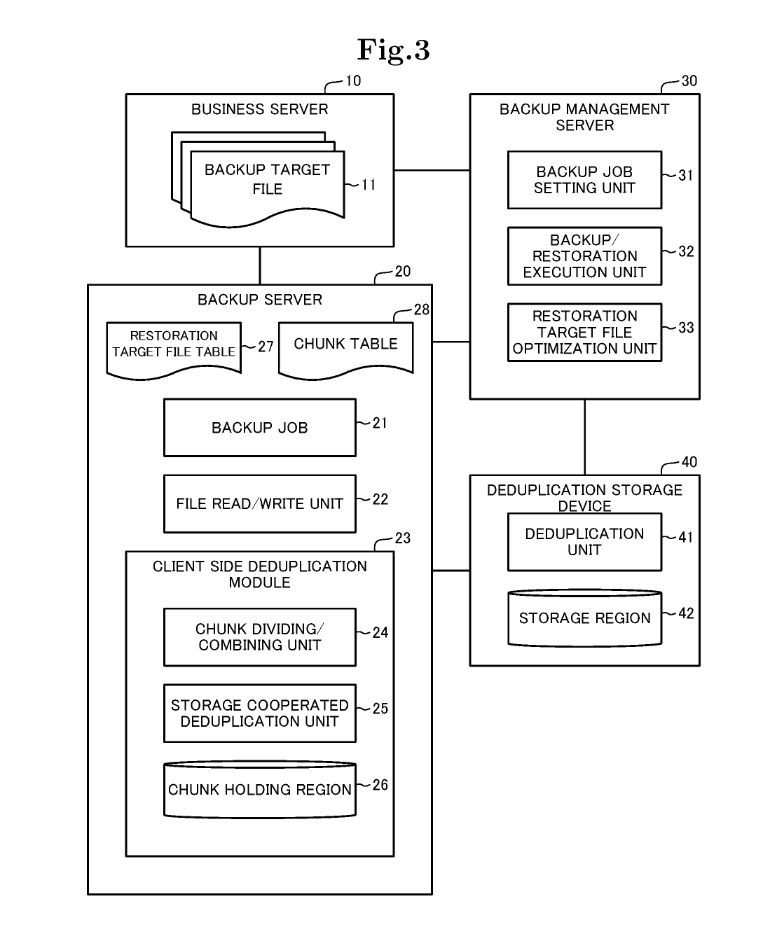

A first exemplary embodiment of the present invention will be described with reference to FIGS. 3 to 9. FIGS. 3 to 5 are diagrams for explaining a configuration of a storage system. FIGS. 6 to 9 are diagrams for explaining operation of the storage system.

### [Configuration]

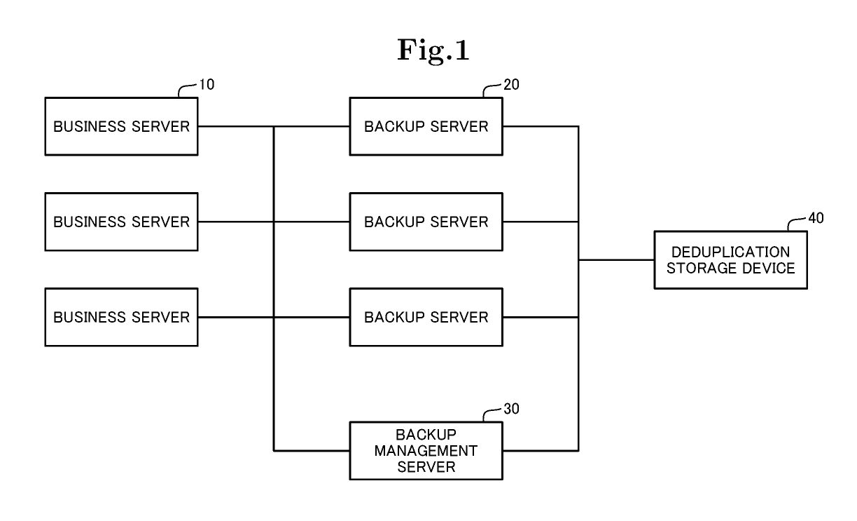

A storage system of the present invention has the same configuration as that of FIG. 1 described above. This means that the storage system includes one or more business servers 10 having backup target data, one or more backup servers 20 that execute a backup process, a backup management server 30 that manages backup, and a deduplication storage device 40 in which backup data is stored. While FIG. 1 illustrates a configuration including three business servers 10, three backup servers 20, one backup management server 30, and one deduplication storage device 40, the number of servers and devices is not limited to that illustrated in FIG. 1.

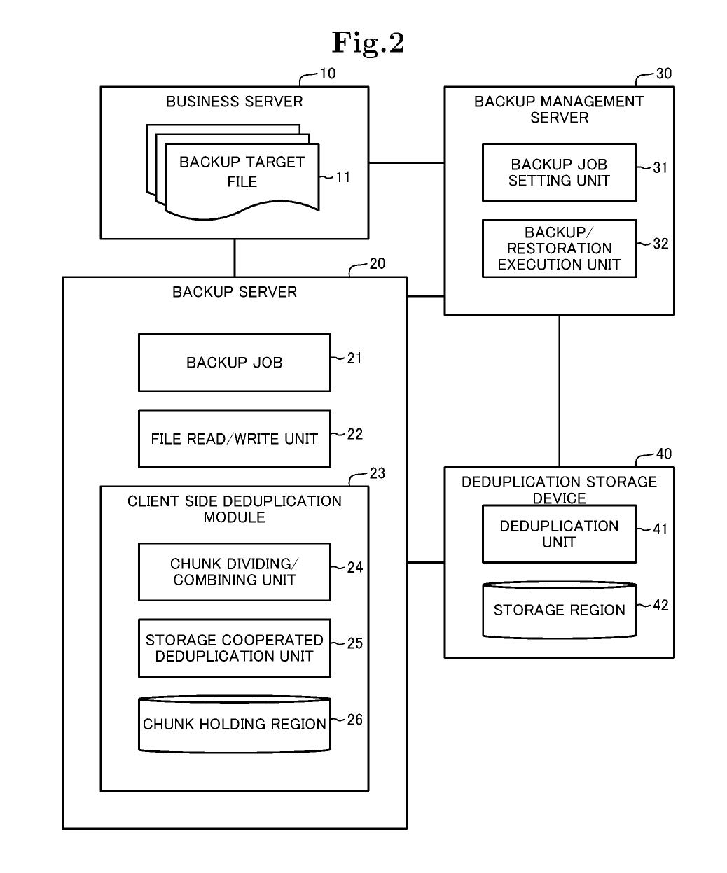

FIG. 3 illustrates constituent elements provided to each of the servers and devices included in the storage system of the present embodiment. The storage system basically has a configuration similar to that of FIG. 2 described above, and also includes some additional constituent elements.

The business server 10 includes one or more backup target files 11.

The backup server 20 includes a file read/write unit 22 for reading out a file from and writing a file into the business server 10 (or deduplication storage device 40). The backup server 20 also includes a backup job 21 that defines which file in the business server 10 should be backed up or restored, and realizes backup of a file in the deduplication storage device 40 or restoration of a file in the business server 10 with use of the file read/write unit 22.

The backup server 20 also includes a client side deduplication module 23 having a chunk dividing/combining unit 24, a storage cooperated deduplication unit 25, and a chunk holding region 26. The chunk dividing/combining unit 24 divides a readout backup target file into chunks (data unit of deduplication: divided data), and distinguishes chunks not having been stored in the deduplication storage device 40 with use of the storage cooperated deduplication unit 25. Then, the storage cooperated deduplication unit 25 writes only new chunks into the deduplication storage device. As for the chunks having been stored, the chunks already stored in the deduplication storage device 40 are allowed to be referred to. The chunk holding region 26 holds part of the divided chunks like a cache in order to speed up restoration.

The backup server 20 functions as a readout device that reads out a file and, at the time of restoration in the business server 10, reads out data in chunk units and creates a file, by the chunk dividing/combining unit 24. At that time, the backup server 20 refers to a restoration target file table (file table) stored therein, as described below.

The backup management server 30 includes a backup job setting unit 31, and sets a backup job 21 of each backup server 20. The backup management server 30 includes a backup/restoration execution unit 32, and controls execution of the backup job 21 of each backup server 20.

The deduplication storage device 40 includes a storage region 42 in which data of the backup target file 11 of the business server 10 is finally stored. The deduplication storage device 40 also includes a deduplication unit 41 having a function of deduplicating written data (dividing data into chunks, managing a correspondence relationship between a chunk and a file, and the like).

In addition, the backup server 20 of the present embodiment also includes a restoration target file table 27 and a chunk table 28. The restoration target file table 27 and the chunk table 28 are held by each backup server 20.

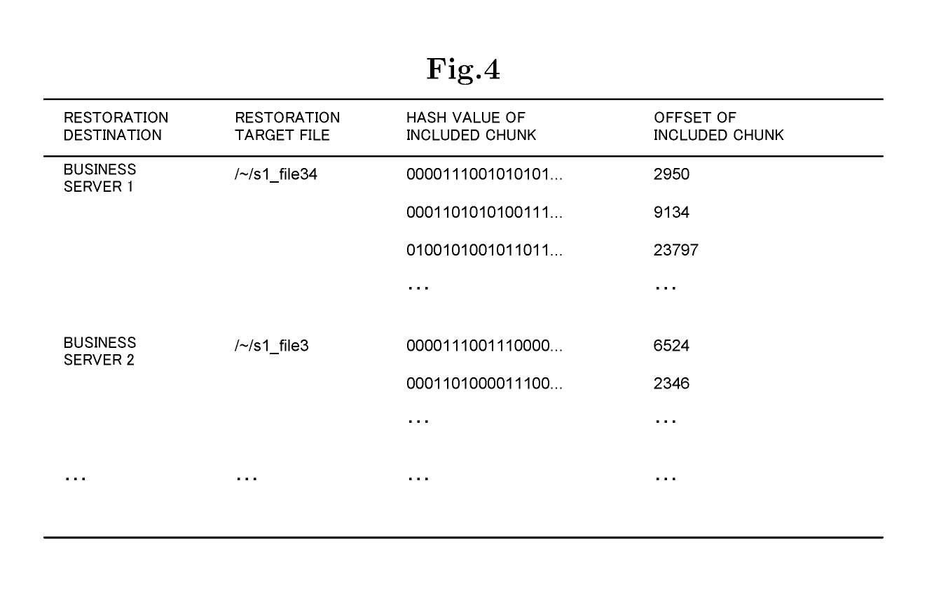

To the restoration target file table 27 (file table), an entry of each restoration target file is added and information for managing the file is stored, at the time of backup. For example, as illustrated in FIG. 4, in the restoration target file table 27, a “restoration destination”, a “path/file name”, a “hash value” of a chunk, and an “offset” of the chunk in the file, of each restoration target file are associated with each other.

The “restoration destination” is information representing the business server 10 (restoration destination device) that is a backup source of the file and a restoration destination. The “path/file name” represents a path and a file name of a restoration target file, which is file specifying information for specifying the restoration target file. The “hash value” is a hash value of each of the chunks constituting a file, is calculated according to the content of the chunk, and serves as divided data specifying information for specifying the chunk. The “offset” is information representing a position of the chunk in a file. In general, one file is configured of a plurality of chunks.

The restoration target file table 27 is referred to when restoration is performed in the backup server 20. This means that the backup server 20 reads out data in chunk units by the chunk dividing/combining unit 24 and creates a file, based on the restoration target file table 27 to thereby restore the data in the business server 10. The restoration target file table 27 may be changed by the backup management server 30 as described below.

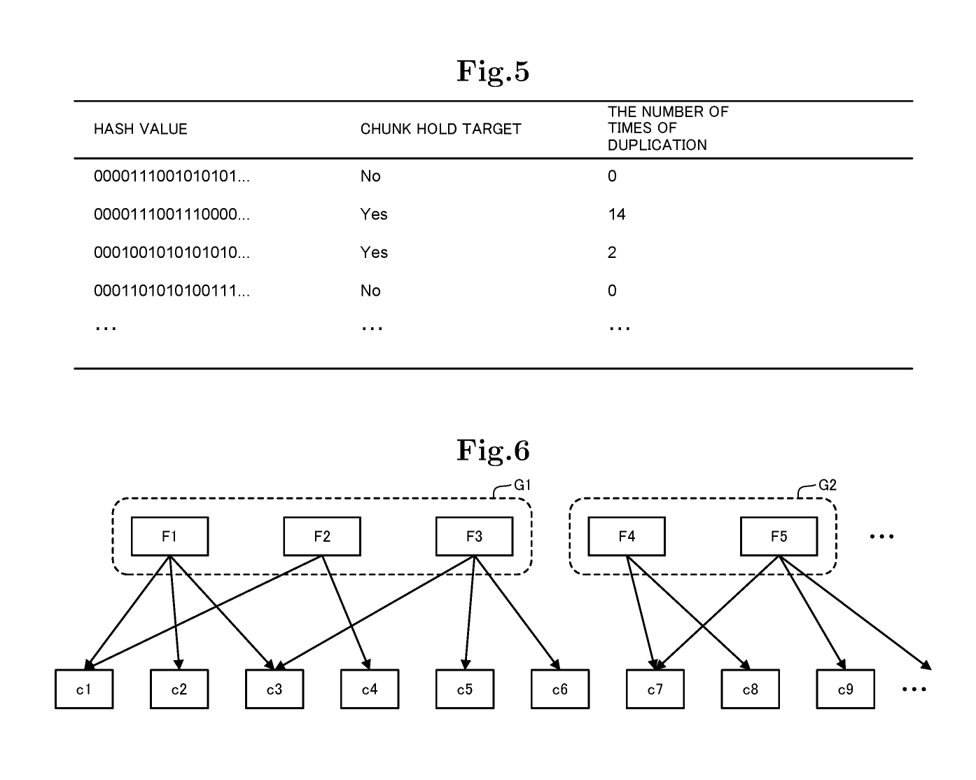

Meanwhile, in the chunk table 28, information of each chunk is stored when backup is performed as described above. For example, the chunk table 28 includes a “hash value” of each chunk, “chunk hold target (yes, no)”, and “the number of times of duplication”, as illustrated in FIG. 5. “Chunk hold target” is information representing whether or not the backup server 20 storing the table handles the chunk as a holding target. “The number of times of duplication” is information representing the number of times of duplication in the data (the entire files in the restoration target file table 27) handled by the backup server 20 in which the table is stored.

The backup management server 30 of the present embodiment includes a restoration target file optimization unit 33. The restoration target file optimization unit 33 functions as a file table acquisition unit that acquires information of the restoration target file tables 27 and the chunk tables 28 from the entire backup servers 20.

The restoration target file optimization unit 33 also functions as a file table change unit that changes the collected restoration target file tables 27. The restoration target file optimization unit 33 changes the restoration target file tables such that a plurality of files associated with the chunks of the same “hash value”, that is, a plurality of files including the same chunk, are put in the same group, and the same group is included in one restoration target file table, for example. At this time, a change is made such that in a group of files including the same chunk, another file including a chunk that is the same as another chunk constituting the files is included, and such a group is included in one restoration target file table. A change of a restoration target file table will be described below in detail in the description of operation.

It is not limited that the restoration target file optimization unit 33 classifies files into groups depending on whether or not the “hash values” of the chunks are the same. For example, it is also possible to change the restoration target file table by putting a plurality of files in the same group by another method such as putting files having chunks of a common feature in the same group, and putting such a group in one restoration target file table.

The restoration target file optimization unit 33 also changes the chunk table 28, along with a change of the restoration target file table 27 described above. This means that when the restoration target file table 27 is changed, the files managed by the backup server 20 are changed. In response to it, information of “chunk hold target” and “the number of times of duplication” of a chunk are changed.

The restoration target file optimization unit 33 also transmits the changed restoration target file table 27 and the changed chunk table 28 to each backup server 20, and updates them.

Then, at the time of restoration or the like, the backup server 20 reads out data in chunk units by the chunk dividing/combining unit 24 from the deduplication storage device 40 and the chunk holding region 26 based on the updated restoration target file table as described above, and creates a file. In the chunk holding region 26, chunks are stored with reference to the chunk table 28 updated based on the updated restoration target file table. For example, in the chunk holding region 26, a chunk shared by a plurality of files included in the same group in a restoration target file table to which the backup server 20 is assigned, is stored. At this time, in the chunk holding region 26, a chunk that is deduplicated a larger number of times in the files is preferentially stored, particularly.

It should be noted that the respective units of the backup server 20, the backup management server 30, and the deduplication storage device 40 are constructed when a program is incorporated in the arithmetic unit provided to each of the servers and devices.

### [Operation]

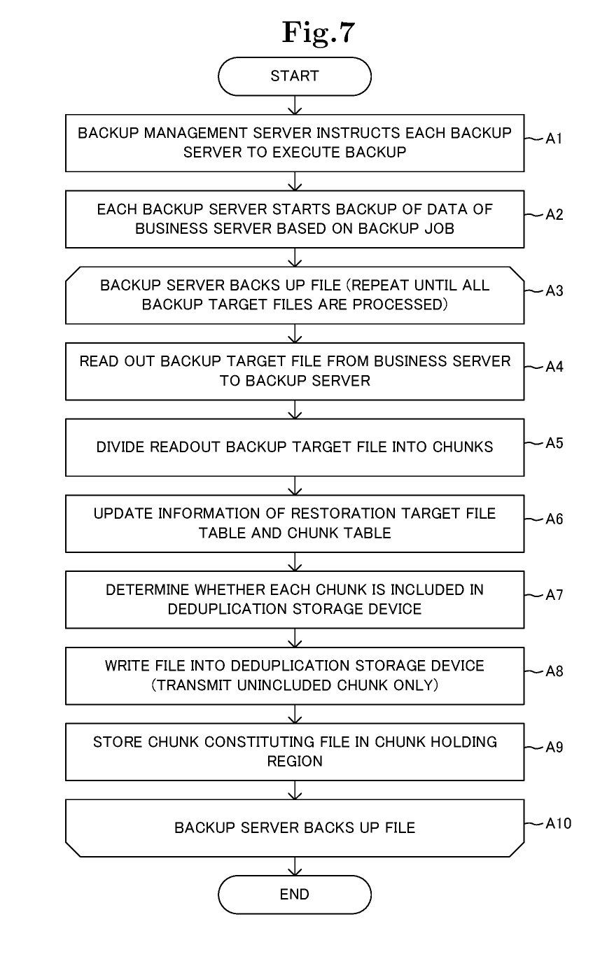

Next, an operation of the storage system configured as described above will be described with reference to FIGS. 6 to 9. FIG. 6 illustrates a state of a process of changing a restoration target file table by the backup management server. FIGS. 7 to 9 are flowcharts illustrating operation of the storage system. In the below description, a backup process, a restoration target update process, and a process at the time of restoration, by the storage system, will be described.

### <Backup Process>

First, a process of backing up data of all business servers 10 (all backup target files 11) will be described with reference to the flowchart of FIG. 7.

First, the backup management server 30 transmits an instruction to start execution of backup to each backup server 20 (step A1).

Then, when a backup target instructed in the backup job is set, the backup server 20 to which execution of backup is instructed from the backup management server 30 backs up the set backup target file 11 (step A2). In this example, all backup target files 11 of all business servers 10 are backed up.

To perform file backup (step A3), first, the backup server 20 reads the backup target file 11 from the business server 10 (step A4). Then, the chunk dividing/combining unit 24 divides the backup target file 11 into chunks (step A5). At this time, division into chunks is performed by a method of dividing the file by a certain number of bites, dividing the file at a position where the hash value of a bit string of the data satisfies a particular condition, or the like.

Then, after the division into chunks, an entry of the file being processed by the backup server 20 is added to the restoration target file table 27 held by the backup server 20. For example, as illustrated in FIG. 4, information including a business server in which the file is placed, the file name/path, hash values of all chunks constituting the file, and an offset is recorded in the restoration target file table 27. Further, in the chunk table 28, a hash value of each chunk processed by the backup server 20, and the number of times that the same chunk appears in the current backup processed by the backup server 20, are recorded (step A6).

Next, the backup server 20 inquires the deduplication storage device 40, and determines, whether or not a chunk has already stored in the deduplication storage device 40, with use of the storage cooperated deduplication unit 25 (step A7). When the chunk is not stored in the deduplication storage device 40, the data of the chunk is written into the deduplication storage device 40. Meanwhile, when the chunk has stored, only a hash value representing the chunk is transmitted to the deduplication storage device 40 (step A8). This means that when the chunk has stored, the chunk stored in the deduplication storage device 40 is referred to by using a content address based on the hash value of the chunk, whereby duplicate storage of the chunk is eliminated.

After the file is written in the deduplication storage device 40 from the backup server 20, chunks created in the chunk dividing process are stored in the chunk holding region 26 of the backup server 20 (step A9). At this time, the total amount of data of the chunks created in one backup is larger than the capacity of the chunk holding region. As such, the chunks to be held in the chunk holding region 26 are selected according to a rule such as LRU.

### <Restoration Target Update Process>

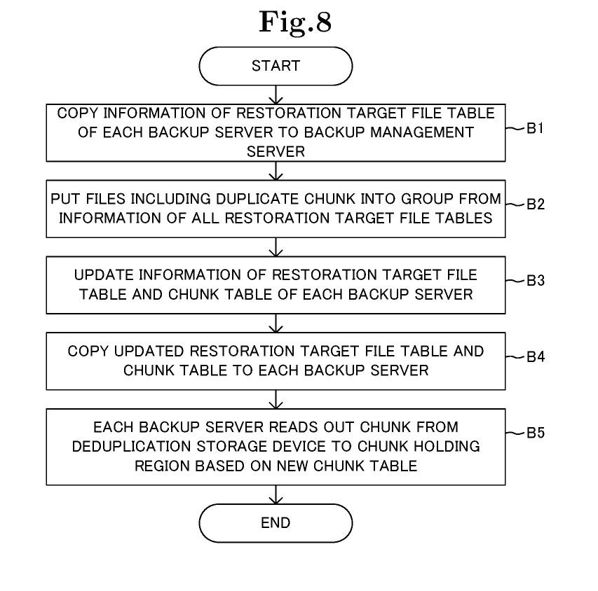

Next, a process of updating a restoration target of each backup server 20 after backup will be described with reference to the flowchart of FIG. 8.

Upon completion of backup, first, the backup management server 30 copies information of the restoration target file tables 27 and the chunk tables 28 stored in all backup servers 20, to the backup management server 30 (step B1). Thereby, information of all of the restoration target files and the chunks, generated in the previous backup, is collected in the backup management server 30.

Next, from the information of all of the files and the chunks of all restoration target file tables 27, files containing the same chunks are checked. Then, a group (or a cluster) is created by integrating the files including the duplicate chunks (step B2). Even in the case where two files does not include the same chunk, when the two files share a chunk of the same third file, the two files are put in the same group. This means that another file that shares at least one chunk with the files included in the same group because a duplicate chunk is included, is also included in the same group.

An example of creating a group will be described with reference to FIG. 6. First, it is assumed that a file F1 is configured of chunks c1, c2, and c3, a file F2 is configured of chunks c1 and c4, a file F3 is configured of chunks c3, c5, and c6, a file F4 is configured of chunks c7 and c8, and a file F5 is configured of chunks c7, c9, and the like. In this case, as both the file F1 and the file F2 include the chunk c1, they are included in the same group G1. Further, as both the file F1 and the file F3 include the chunk c3, they are included in the same group G1. Accordingly, although the file F2 and the file F3 do not have the same chunk, all of the files F1, F2, and F3 are included in the same group G1. Meanwhile, both the file F4 and the file F5 include the chunk c7. However, they do not have a chunk that is the same as that in the files of the group G1. Accordingly, the files F4 and F5 are included in a group G2 different from the group G1.

Through the aforementioned process, a plurality of groups of files having duplicate parts are created. There also remain a plurality of files not having a duplicate chunk and not included in any group.

Next, along with the creation of the groups, in the backup management server 30, contents of the restoration target file table and the chunk table in each of the backup servers 20 are changed, whereby updated new restoration target file table and chunk table are created (step B3). At this time, files are included in the restoration target file table of each backup server 20 (restoration is assigned) in accordance with the policies described below.

Policy 1

Regarding the files included in the same group created at step B2, restoration is assigned to the same backup server 20. This means that one group is included in one restoration target file table, and is assigned to one backup server 20. At this time, a plurality of groups are distributively assigned to respective backup servers 20 uniformly. Further, restoration of the files is assigned such that the total capacity of the files in a group becomes almost uniform among the backup servers 20.

Policy 2

Restoration of files is assigned such that data of the business servers 10 is assigned uniformly to the respective backup servers 20. This means that restoration is assigned such that even if any business server 10 is selected at the time of restoration, the files in such a business server 10 are uniformly distributed to all backup servers 12. At this time, restoration is assigned such that the capacity of the data and the number of files of each business server 10 are distributed uniformly to all backup servers 20.

When the restoration target file table assigned to each backup server 20 is updated in accordance with the aforementioned policies, a chunk table assigned to each backup server 20 is updated so as to correspond to the content of the restoration target file table. At this time, the number of times of duplication of a chunk in the assigned backup server 20 is updated, and in the chunk table, the chunk hold target of a chunk that the number of times of duplication is large is marked with “yes” preferentially. The chunk with this mark indicates that it is to be stored in the chunk holding region 26 in the assigned backup server 20.

Next, information of the restoration target file table and the chunk table assigned to each backup server 20, updated in the backup management server 30, is copied to each backup server 20. Thereby, the old table is updated to have information of the new table (step B4).

Finally, each backup server 20 reads out a chunk that is a holding target chunk in the updated new chunk table from the deduplication storage device 40, and stores it in the chunk holding region 26 (step B5).

### <Restoration Process>

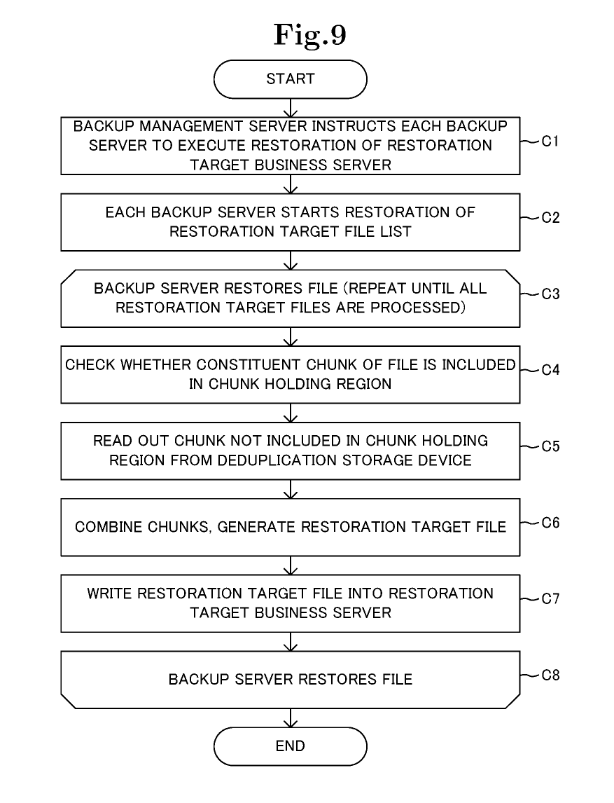

Next, a process of restoration in any of the business servers 10 will be described with reference to the flowchart of FIG. 9.

First, the backup management server 30 instructs all backup servers 20 to execute restoration of the restoration target business server 10 (step C1). When receiving an instruction of execution of restoration, each backup server 20 performs restoration of all files of the restoration target business server 10, among the files in the assigned restoration target file table stored therein (step C2).

Then, for each file to be restored, first, it is checked whether or not the constituent chunks described in the restoration target file table are included in the chunk holding region 26 (step C4). A files not included in the chunk holding region 26 is read out from the deduplication storage device 40 (step C5), and is combined with the chunks included in the chunk holding region 26, whereby a restoration target file is generated (step C6). Finally, the restoration target file generated by the backup server 20 is written into the restoration target business server 10, whereby restoration is completed (step C7).

As described above, according to the storage system of the present invention, a restoration target file table is changed as described above. This is effective at the time of restoration and readout of files, as described below.

First, files included in the same group are files having duplicate chunks. As such, by assigning the same backup server 20 and allowing duplicate chunks to be preferentially included in the chunk holding region 26, it is possible to create a file at high speed by one backup server 20. Further, in the chunk holding region 26, chunk deduplication is performed efficiently, and a chunk can be provided to a plurality of files with the capacity of one chunk.

For example, the aforementioned example describes the case where the file F1 is configured of the chunks c1, c2, and c3 and the file F2 is configured of the chunks c1 and c4, and these files are included in the same group. Here, the total number of chunks included in the files F1 and F2 is five. However, as the chunk c1 is shared by them, when a file is created by the same backup server 20, it is possible to read out all chunks constituting both files only with the four chunks c1, c2, c3, and c4. Accordingly, chunk readout efficiency is improved, whereby restoration can be performed efficiently at high speed. Further, by preferentially storing chunks that are duplicate in a plurality of files in the same chunk holding region 26, the capacity efficiency of the chunk holding region 26 is increased, and an effect as a cache of the chunks at the time of restoration is improved.

Further, by arranging the groups, created as described above, uniformly among the backup servers 20, an effect of improving the capacity efficiency of the chunk holding region 26 is equally applied to the chunk holding regions of all backup servers 20. Further, a load of restoration can be distributed among the backup servers 20.

Further, as backup is performed while files of the business servers 10 are uniformly distributed among the respective backup servers 20, a load of restoration can be distributed among the respective backup servers 20. Further, it is possible to prevent concentration of a network band between the restoration target business server 10 and each backup server 20 on a particular position, whereby the entire band can be used. Therefore, the transfer speed at the time of restoration can be higher.

In the description provided above, the case where a restoration target file table and a chunk table are changed by the backup management server 30 has been described as an example. However, the function of performing such a process may be provided to the backup server 20, the deduplication storage device 40, or another server. It is also possible that a restoration target file table and a chunk table held by each backup server 20 may be stored in the deduplication storage device 40 or another server, by specifying the backup server 20 to which such a table is assigned.

### Second Exemplary Embodiment

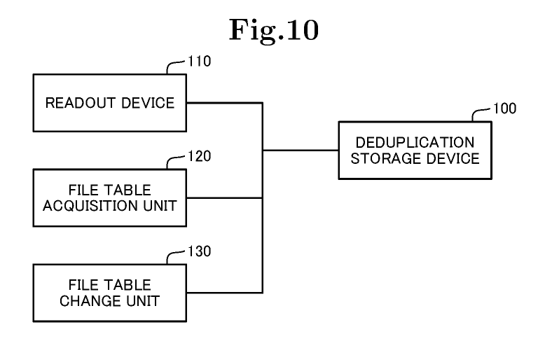

Next, a second exemplary embodiment of the present invention will be described with reference to FIG. 10. FIG. 10 is a block diagram illustrating a configuration of a storage system according to the second exemplary embodiment. The storage system of the present embodiment illustrates an outline of the configuration of the storage system described in the first exemplary embodiment.

As illustrated in FIG. 10, a storage system of the present embodiment includes

a deduplication storage device 100 configured to store divided data obtained by dividing a file into a plurality of units, and eliminate duplicate storage by referring to the divided data of the same content that is already stored, and

a plurality of readout devices 110 each configured to read out a file from the deduplication storage device 100, based on a file table showing a file storing state in the deduplication storage device 100.

The storage system includes

a file table acquisition unit 120 configured to acquire a file table in which file specifying information that specifies a file and divided data specifying information that specifies divided data constituting the file are associated with each other, and

a file table change unit 130 configured to change the file table such that a plurality of files constitute a group based on the file table.

With the configuration described above, in the deduplication storage device 100 in which duplicate divided data constituting a file is eliminated, a file table is changed such that a plurality of files form a group, on the basis of a relationship between the files and the divided data. Then, based on a group of the changed file table, the readout device reads out divided data and creates a file. Thereby, it is possible to read out a file efficiently, and speed up readout and restoration.

### <Supplementary Notes>

The whole or part of the exemplary embodiments disclosed above can be described as, but not limited to, the following supplementary notes. Hereinafter, outlines of the configurations of a storage system, an information processing apparatus, a storage device, a program, and an information processing method according to the present invention will be described. However, the present invention is not limited to the configurations described below.

### (Supplementary Note 1)

A storage system comprising:

a deduplication storage device configured to store divided data units obtained by dividing a file into a plurality of data units, and eliminate duplicate storage by referring to the divided data unit of a same content that is already stored;

a plurality of readout devices each configured to read out the file from the deduplication storage device, based on a file table showing a storing state of the file in the deduplication storage device;

a file table acquisition unit configured to acquire the file table in which file specifying information that specifies the file and divided data specifying information that specifies the divided data unit constituting the file are associated with each other; and

a file table change unit configured to change the file table such that a plurality of the files constitute a group, based on the file table.

### (Supplementary Note 2)

The storage system according to supplementary note 1, wherein

the file table change unit changes the file table such that a plurality of the files having the divided data units of a common feature are included in a same group.

### (Supplementary Note 3)

The storage system according to supplementary note 1 or 2, wherein

the file table change unit changes the file table such that a plurality of the files in which the divided data specifying information of at least one of the divided data units, associated with the files, is same are included in a same group.

### (Supplementary Note 4)

The storage system according to supplementary note 3, wherein

the file table change unit changes the file table such that the group including the files in which the divided data specifying information of the at least one of the divided data units, associated with the files, is the same includes another file having the divided data specifying information that is same as the divided data specifying information of at least one of the divided data units constituting the files included in the group.

### (Supplementary Note 5)

The storage system according to any of supplementary notes 1 to 4, wherein

each of the readout devices is assigned with the file table, and is configured to read out the file from the deduplication storage device based on the assigned file table, and

the file table change unit changes the file table such that the group is included in one of the file tables.

### (Supplementary Note 6)

The storage system according to supplementary note 5, wherein

the file table change unit changes the file table such that the group is distributively included in a plurality of the file tables respectively assigned to the readout devices.

### (Supplementary Note 7)

The storage system according to supplementary note 5 or 6, wherein

each of the readout devices includes a divided data holding region for storing the divided data unit, and is configured to read out the file from the divided data holding region and from the deduplication storage device, and

the file table change unit stores, in the divided data holding region, the divided data unit shared by the files included in the same group, based on the changed file table.

### (Supplementary Note 8)

The storage system according to any of supplementary notes 1 to 7, wherein

the file table includes information of a restoration destination device serving as a restoration destination of the file, and

the file table change unit changes the file table such that the restoration destination devices are distributively included in a plurality of the file tables respectively assigned to the readout devices.

### (Supplementary Note 9)

The storage system according to any of supplementary notes 1 to 8, wherein

the readout device backs up the file in the deduplication storage device by eliminating duplicate storage, from a server in which the file is stored, and generates the file table showing a storing state of the backed-up file, and

the readout device reads out the file stored in the deduplication storage device and restores the file in the server, based on the changed file table.

### (Supplementary Note 10)

An information processing apparatus comprising:

a file table acquisition unit configured to acquire a file table; and

a file table change unit, wherein

the file table shows a storing state of a file in a deduplication storage device configured to store divided data units obtained by dividing the file into a plurality of data units and eliminate duplicate storage by referring to the divided data unit of a same content that is already stored, and the file table is configured such that file specifying information that specifies the file and divided data specifying information that specifies the divided data unit constituting the file are associated with each other, and

the file table change unit is configured to change the file table such that a plurality of the files constitute a group, based on the file table.

### (Supplementary Note 10.1)

The information processing apparatus according to supplementary note 10, wherein

the file table change unit changes the file table such that a plurality of the files having the divided data units of a common feature are included in a same group.

### (Supplementary Note 10.2)

The information processing apparatus according to supplementary note 10 or 10.1, wherein

the file table change unit changes the file table such that a plurality of the files in which the divided data specifying information of at least one of the divided data units, associated with the files, is same are included in a same group.

### (Supplementary Note 10.3)

The information processing apparatus according to supplementary note 10.2, wherein

the file table change unit changes the file table such that the group including the files in which the divided data specifying information of the at least one of the divided data units, associated with the files, is the same includes another file having the divided data specifying information that is same as the divided data specifying information of at least one of the divided data units constituting the files included in the group.

### (Supplementary Note 10.4)

The information processing apparatus according to any of supplementary notes 10 to 10.3, wherein

the file table is assigned to each of the readout devices, and each of the readout devices is configured to read out the file from the deduplication storage device based on the assigned file table, and

the file table change unit changes the file table such that the group is included in one of the file tables.

### (Supplementary Note 10.5)

The information processing apparatus according to supplementary note 10.4, wherein

the file table change unit changes the file table such that the group is distributively included in a plurality of the file tables respectively assigned to the readout devices.

### (Supplementary Note 10.6)

The information processing apparatus according to any of supplementary notes 10 to 10.5, wherein

the file table includes information of a restoration destination device serving as a restoration destination of the file, and

the file table change unit changes the file table such that the restoration destination devices are distributively included in a plurality of the file tables respectively assigned to the readout devices.

### (Supplementary Note 11)

A non-transitory computer-readable medium storing a program comprising instructions for causing an information processing apparatus to realize:

a file table acquisition unit configured to acquire a file table; and

a file table change unit, wherein

the file table shows a storing state of a file in a deduplication storage device configured to store divided data units obtained by dividing the file into a plurality of data units and eliminate duplicate storage by referring to the divided data unit of a same content that is already stored, and the file table is configured such that file specifying information that specifies the file and divided data specifying information that specifies the divided data unit constituting the file are associated with each other, and

the file table change unit is configured to change the file table such that a plurality of the files constitute a group, based on the file table.

### (Supplementary Note 11.1)

The non-transitory computer-readable medium storing the program according to supplementary note 11, wherein

the file table change unit changes the file table such that a plurality of the files having the divided data units of a common feature are included in a same group.

### (Supplementary Note 11.2)

The non-transitory computer-readable medium storing the program according to supplementary note 11 or 11.1, wherein

the file table change unit changes the file table such that a plurality of the files in which the divided data specifying information of at least one of the divided data units, associated with the files, is same are included in a same group.

### (Supplementary Note 11.3)

The non-transitory computer-readable medium storing the program according to supplementary note 11.2, wherein

the file table change unit changes the file table such that the group including the files in which the divided data specifying information of the at least one of the divided data units, associated with the files, is the same includes another file having the divided data specifying information that is same as the divided data specifying information of at least one of the divided data units constituting the files included in the group.

### (Supplementary Note 11.4)

The non-transitory computer-readable medium storing the program according to any of supplementary notes 11 to 11.3, wherein

the file table is assigned to each of the readout devices, and each of the readout devices is configured to read out the file from the deduplication storage device based on the assigned file table, and

the file table change unit changes the file table such that the group is included in one of the file tables.

### (Supplementary Note 11.5)

The non-transitory computer-readable medium storing the program according to supplementary note 11.4, wherein

the file table change unit changes the file table such that the group is distributively included in a plurality of the file tables respectively assigned to the readout devices.

### (Supplementary Note 11.6)

The non-transitory computer-readable medium storing the program according to any of supplementary notes 11 to 11.5, wherein

the file table includes information of a restoration destination device serving as a restoration destination of the file, and

the file table change unit changes the file table such that the restoration destination devices are distributively included in a plurality of the file tables respectively assigned to the readout devices.

### (Supplementary Note 12)

An information processing method performed by a storage system including a deduplication storage device and a plurality of readout devices, the deduplication storage device being configured to store divided data units obtained by dividing a file into a plurality of data units and eliminate duplicate storage by referring to the divided data unit of a same content that is already stored, each of the readout devices being configured to read out the file from the deduplication storage device based on a file table showing a storing state of the file in the deduplication storage device, the method comprising:

acquiring a file table in which file specifying information that specifies the file and divided data specifying information that specifies the divided data unit constituting the file are associated with each other; and

changing the file table such that a plurality of the files constitute a group, based on the file table.

### (Supplementary Note 13)

The information processing method according to supplementary note 12, further comprising

changing the file table such that a plurality of the files having the divided data units of a common feature are included in a same group.

### (Supplementary Note 14)

The information processing method according to supplementary note 12 or 13, further comprising

changing the file table such that a plurality of the files in which the divided data specifying information of at least one of the divided data units, associated with the files, is same are included in a same group.

### (Supplementary Note 15)

The information processing method according to supplementary note 14, further comprising

changing the file table such that the group including the files in which the divided data specifying information of the at least one of the divided data units, associated with the files, is the same includes another file having the divided data specifying information that is same as the divided data specifying information of at least one of the divided data units constituting the files included in the group.

### (Supplementary Note 16)

The information processing method according to any of supplementary notes 12 to 15, wherein

each of the readout devices is assigned with the file table, and is configured to read out the file from the deduplication storage device based on the assigned file table, and

the method further comprises changing the file table such that the group is included in one of the file tables.

### (Supplementary Note 17)

The information processing method according to supplementary note 16, further comprising

changing the file table such that the group is distributively included in a plurality of the file tables respectively assigned to the readout devices.

### (Supplementary Note 18)

The information processing method according to supplementary note 15 or 16, wherein

each of the readout devices includes a divided data holding region for storing the divided data unit, and is configured to read out the file from the divided data holding region and from the deduplication storage device, and

the method further comprises storing, in the divided data holding region, the divided data unit shared by the files included in the same group, based on the changed file table.

### (Supplementary Note 19)

The information processing method according to any of supplementary notes 12 to 18, wherein

the file table includes information of a restoration destination device serving as a restoration destination of the file, and

the method further comprises changing the file table such that the restoration destination devices are distributively included in a plurality of the file tables respectively assigned to the readout devices.

The aforementioned program may be stored in a storage device or on a computer-readable storage medium. For example, a storage medium is a portable medium such as a flexible disk, an optical disk, a magneto-optical disk, a semiconductor memory, or the like.

While the present invention has been described with reference to the exemplary embodiments described above, the present invention is not limited to the above-described embodiments. The form and details of the present invention can be changed within the scope of the present invention in various manners that can be understood by those skilled in the art.

### REFERENCE SIGNS LIST

10 business server
11 backup target file
20 backup server
21 backup job
22 file read/write unit
23 client side deduplication module
24 chunk dividing/combining unit
25 storage cooperated deduplication unit
26 chunk holding region
27 restoration target file table
28 chunk table
30 backup management server
31 backup job setting unit
32 backup/restoration execution unit
33 restoration target file optimization unit
40 deduplication storage device
41 deduplication unit
42 storage region
100 deduplication storage device
110 readout device
120 file table acquisition unit
130 file table change unit

1. A storage system comprising:
a deduplication storage device configured to store divided data units obtained by dividing a file into a plurality of data units, and eliminate duplicate storage by referring to the divided data unit of a same content that is already stored;
a plurality of readout devices each configured to read out the file from the deduplication storage device, based on a file table showing a storing state of the file in the deduplication storage device;
a file table acquisition unit configured to acquire the file table in which file specifying information that specifies the file and divided data specifying information that specifies the divided data unit constituting the file are associated with each other; and
a file table change unit configured to change the file table such that a plurality of the files constitute a group, based on the file table.

2. The storage system according to claim 1, wherein
the file table change unit changes the file table such that a plurality of the files having the divided data units of a common feature are included in a same group.

3. The storage system according to claim 1, wherein
the file table change unit changes the file table such that a plurality of the files in which the divided data specifying information of at least one of the divided data units, associated with the files, is same are included in a same group.

4. The storage system according to claim 3, wherein
the file table change unit changes the file table such that the group including the files in which the divided data specifying information of the at least one of the divided data units, associated with the files, is the same includes another file having the divided data specifying information that is same as the divided data specifying information of at least one of the divided data units constituting the files included in the group.

5. The storage system according to claim 1, wherein
each of the readout devices is assigned with the file table, and is configured to read out the file from the deduplication storage device based on the assigned file table, and
the file table change unit changes the file table such that the group is included in one of the file tables.

6. The storage system according to claim 5, wherein
the file table change unit changes the file table such that the group is distributively included in a plurality of the file tables respectively assigned to the readout devices.

7. The storage system according to claim 5, wherein
each of the readout devices includes a divided data holding region for storing the divided data unit, and is configured to read out the file from the divided data holding region and from the deduplication storage device, and
the file table change unit stores, in the divided data holding region, the divided data unit shared by the files included in the same group, based on the changed file table.

8. The storage system according to claim 1, wherein
the file table includes information of a restoration destination device serving as a restoration destination of the file, and
the file table change unit changes the file table such that the restoration destination devices are distributively included in a plurality of the file tables respectively assigned to the readout devices.

9. The storage system according to claim 1, wherein
the readout device backs up the file in the deduplication storage device by eliminating duplicate storage, from a server in which the file is stored, and generates the file table showing a storing state of the backed-up file, and
the readout device reads out the file stored in the deduplication storage device and restores the file in the server, based on the changed file table.

10. An information processing apparatus comprising:
a file table acquisition unit configured to acquire a file table; and
a file table change unit, wherein
the file table shows a storing state of a file in a deduplication storage device configured to store divided data units obtained by dividing the file into a plurality of data units and eliminate duplicate storage by referring to the divided data unit of a same content that is already stored, and the file table is configured such that file specifying information that specifies the file and divided data specifying information that specifies the divided data unit constituting the file are associated with each other, and
the file table change unit is configured to change the file table such that a plurality of the files constitute a group, based on the file table.

11. The information processing apparatus according to claim 10, wherein
the file table change unit changes the file table such that a plurality of the files having the divided data units of a common feature are included in a same group.

12. The information processing apparatus according to claim 10, wherein
the file table change unit changes the file table such that a plurality of the files in which the divided data specifying information of at least one of the divided data units, associated with the files, is same are included in a same group.

13. An information processing method performed by a storage system including a deduplication storage device and a plurality of readout devices, the deduplication storage device being configured to store divided data units obtained by dividing a file into a plurality of data units and eliminate duplicate storage by referring to the divided data unit of a same content that is already stored, each of the readout devices being configured to read out the file from the deduplication storage device based on a file table showing a storing state of the file in the deduplication storage device, the method comprising:
acquiring a file table in which file specifying information that specifies the file and divided data specifying information that specifies the divided data unit constituting the file are associated with each other; and
changing the file table such that a plurality of the files constitute a group, based on the file table.

14. The information processing method according to claim 13, further comprising
changing the file table such that a plurality of the files having the divided data units of a common feature are included in a same group.

15. The information processing method according to claim 13, further comprising
changing the file table such that a plurality of the files in which the divided data specifying information of at least one of the divided data units, associated with the files, is same are included in a same group.

16. The information processing method according to claim 15, further comprising
changing the file table such that the group including the files in which the divided data specifying information of the at least one of the divided data units, associated with the files, is the same includes another file having the divided data specifying information that is same as the divided data specifying information of at least one of the divided data units constituting the files included in the group.

17. The information processing method according to claim 13, wherein
each of the readout devices is assigned with the file table, and is configured to read out the file from the deduplication storage device based on the assigned file table, and
the method further comprises changing the file table such that the group is included in one of the file tables.

18. The information processing method according to claim 17, further comprising
changing the file table such that the group is distributively included in a plurality of the file tables respectively assigned to the readout devices.

19. The information processing method according to claim 16, wherein
each of the readout devices includes a divided data holding region for storing the divided data unit, and is configured to read out the file from the divided data holding region and from the deduplication storage device, and
the method further comprises storing, in the divided data holding region, the divided data unit shared by the files included in the same group, based on the changed file table.

20. The information processing method according to claim 13, wherein
the file table includes information of a restoration destination device serving as a restoration destination of the file, and
the method further comprises changing the file table such that the restoration destination devices are distributively included in a plurality of the file tables respectively assigned to the readout devices.
